(19) United States
(12) Patent Application Publication
(10) Pub. No.: US 2002/0165026 A1
(43) Pub. Date: Nov. 7, 2002

(54) Method and system for delivering and securing computer game content via the internet

(76) Inventors: James Harold Perkins, Scottsdale, AZ (US); David Alan Adams, Phoenix, AZ (US); Katherine Mary Schauer, Scottsdale, AZ (US); Heather Jeanette Clark, Scottsdale, AZ (US)

Correspondence Address: WEISS & MOY PC, 4204 NORTH BROWN AVENUE, SCOTTSDALE, AZ, 85251, US

(21) Appl. No.: 09/847,820

(22) Filed: May 1, 2001

(51) Int. Cl. A63F 13/00

(52) U.S. Cl. 463/42; 463/1; 463/43

(57) ABSTRACT

A method and system for delivering and securing computer game content via the Internet provides a customized interface from which an end-user may purchase episodic game content wherein game content is secured to the user's computer. A computer game interface lists game episodes that are installed on the end-user's computer, as well as episodes that are available that have not been purchased by the end-user. The episodes that are installed may be started from the interface and episodes that are not installed may be purchased through the interface. Upon purchase of the game, a security mechanism communicates information that uniquely identifies the end-user's computer to a server that then customizes the software before transmitting it to the end-user's computer. The customization provides protection for game software publishers from unauthorized copying and use of the game content.

### BACKGROUND OF THE INVENTION

1. Field of the Invention

The present invention relates generally to Internet software delivery, and more specifically, to a method and system for delivering and securing computer game content via the internet.

2. Background of the Invention

Present-day Internet software delivery systems provide a mechanism for selling and/or delivering software content in a manner that is immediately accessible to the end-user. While Internet delivery is very desirable to the end-user for its immediacy, Internet delivery has been undesirable for computer game manufacturers, since the content can be copied and in some situations modified to overcome software protection schemes that are designed to ensure that a particular end-user is entitled to use the content.

A web site on the World-Wide-Web (WWW) provides a user interface and access to a server that contains game software. A mechanism that has been used to deliver software is file transfer protocol (FTP), which permits an end-user to download files. Downloading of files may be made conditional upon an Internet “shopping model”, permitting an end-user to purchase game software, but once the download has been made, the software can be copied and given to other prospective customers. If a key mechanism is used, such as is common with shareware programs. The end-user must contact the software vendor to obtain a key that will unlock their software. However, the key may also be passed along to other prospective customers, permitting the unauthorized and subsequent use of the software by multiple persons, where the key was intended to enable only one end user to use the software.

Additionally, WWW sites may present a list of files in a download area or a graphical interface showing game software offerings, but the web pages used to show game offerings are not typically customized for a particular end user and are not interactive with the game itself.

Therefore, it would be desirable to provide a method and system for delivering game content via the Internet. It would further be desirable to provide an interface for purchasing software that is customized for a particular end-user.

### SUMMARY OF THE INVENTION

The above objective of delivering software game content securely via the Internet and provided within a customized interface is accomplished in a method and system for delivery of computer game content and securing game content. A list of game episodes is presented to a game user on a visual display and in response to selecting an episode that is not installed, a purchasing/download sequence is initiated. The purchasing/download sequence includes customizing game content in conformity with information that is transmitted to a server that uniquely identifies a particular end-user computer.

Computer program products for execution on an end-user computer or a server may implement methods of the present invention.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in which the present invention may be practiced.

FIG. 2 is a block diagram depicting software modules in accordance with a preferred embodiment of the present invention.

FIG. 3 is a flowchart depicting operation of the end-user side software in accordance with a preferred embodiment of the present invention.

FIG. 4 is a flowchart depicting operation of the server-side software in accordance with a preferred embodiment of the present invention.

FIG. 5 is a pictorial diagram depicting a user interface in accordance with a preferred embodiment of the present invention.

### DETAILED DESCRIPTION OF THE PREFERRED EMBODIMENTS

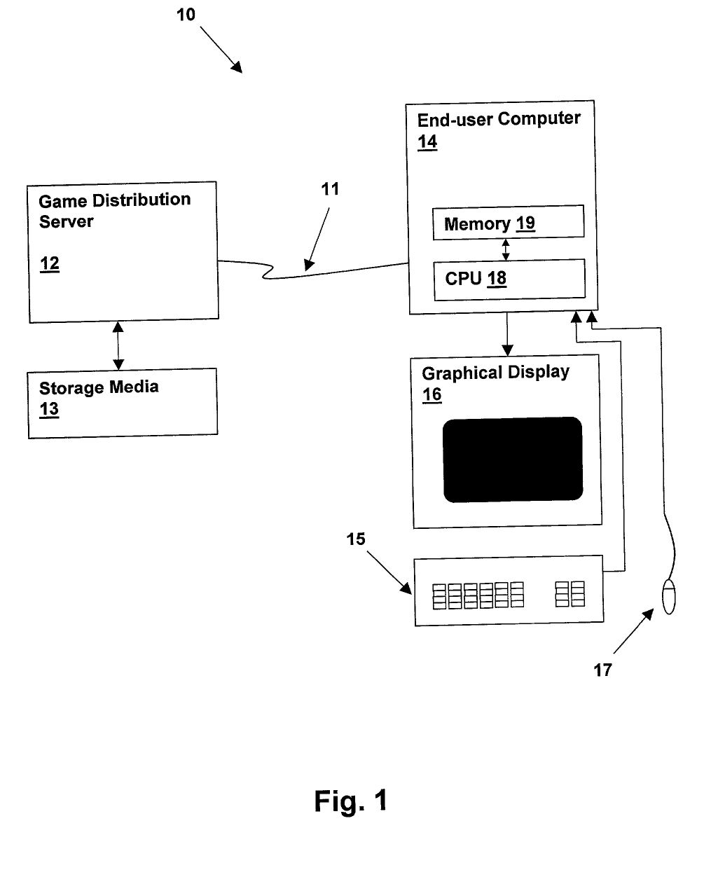

Referring now to the figures and in particular to FIG. 1, a networked computer system 10 within which a preferred embodiment of the present invention may be practiced is depicted in a block diagram. Networked computer system 10 comprises a game distribution server 12 coupled to storage media 13, which is generally a hard disk array containing server software and other files. Game distribution server 12 serves web pages and provides file transfer over Internet connections such as Internet connection 11. Internet connection 11 couples an end-user computer 14 to game distribution server 12. End-user computer 14 has a central processing unit (CPU or processor) for executing program instructions contained in a memory 19 that embody methods of the present invention. Memory 19 should be understood to include non-volatile storage such as hard disk drives and non-volatile memory. End-user computer 14 is coupled to a graphical display on which the user interfaces of the present invention are presented for interaction with a game user. A keyboard 15, a mouse 17 and other suitable input devices may be coupled to end-user computer 14 to permit the game user to interact with programs executing within end-user computer 14.

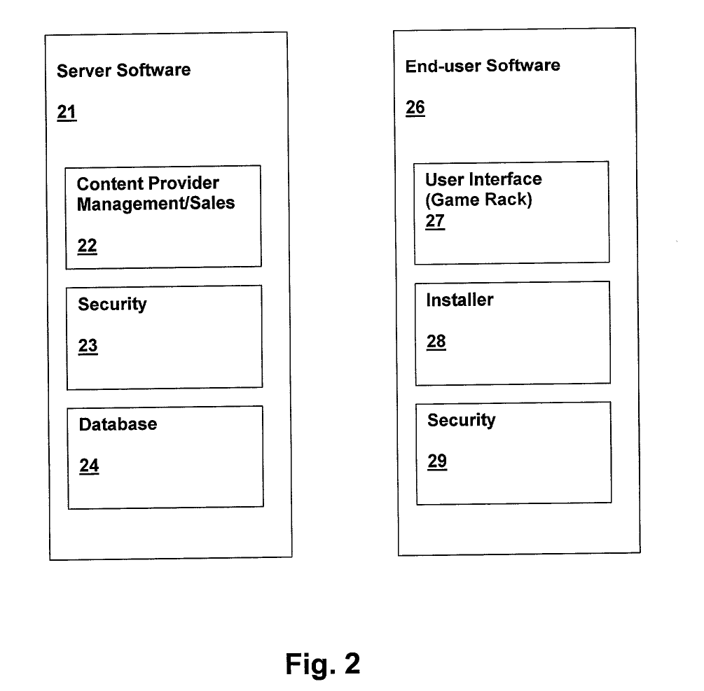

The present invention is embodied in methods, systems and software for delivering and securing game content from game distribution server 12 to end-user computer 14. Referring now to FIG. 2, software modules in accordance with a preferred embodiment of the present invention are depicted. Server software 21 includes a content provider management/sales module 22. Content provider management/sales module 22 serves web page content and other content to provide interaction with purchasing interfaces within end-user software 26. In contrast to a typical Internet purchasing web-page, the purchasing functions of the present invention are embedded within a user interface 27 or “game rack” within end-user software 26 that integrates seamlessly the operation of the game, purchase of additional game episodes, marketing features such as Internet updateable advertisements and other features that enhance the experience of the game user and presence of the game provider within the game user's computer (end-user computer).

Server software 21 also includes a security module 23 that may provide digital rights management and other security features important to the practice of the present invention. Digital rights management generally involves embedding of digital signature and copyright information to technologically aid in the enforcement of copyright and other regulations that are designed to prevent unauthorized use and copying of software. While digital rights management is desirable for increased protection, it is not necessary to the practice of the present invention. Alternative security structures may be employed such as modifying executable code within the game content downloaded to end-user computer 14. Server software 21 also includes a database 24 that may store game user and purchaser information. After a game user has initially purchased game software or downloaded free demos, the information about the game user, including credit card account or Internet account information to be used with subsequent purchases may be stored and retrieved from database 24 when the game user selects subsequent game episodes for download.

End-user software 26 is presented to the user via the game rack user interface 27 described above. The interface provides a consistent platform for starting game episodes and downloading new games or episodes. An installer module 28 within end-user software 26 manages the installation of new episodes. Information uniquely identifying end-user computer 14 is transmitted by the installer module 28 over Internet connection 11 to game distribution server 12 and after game distribution server 12 has customized the game content for download and transmitted the download, installer 28 installs the episode within end-user computer 14 and updates the user interface 27 to recognize the newly downloaded content as an installed episode. Alternatively, the installer 28 may perform customization of the software within end-user computer 14, but this is not preferred since the transmission of the game content might be intercepted and used to create another copy usable on another end-user computer. Customization at the end-user computer 14 should be regarded as an equivalent method, but not a preferred method.

Security module 29 provides periodic checks to ensure that game content is executed on only the end-user computer for which is it customized. Security module 29 may include decryption software for decrypting games content stored as encrypted files and may include encryption software for encrypting the information that is transmitted to game distribution server 12 for customization of the game content for end-user computer 14.

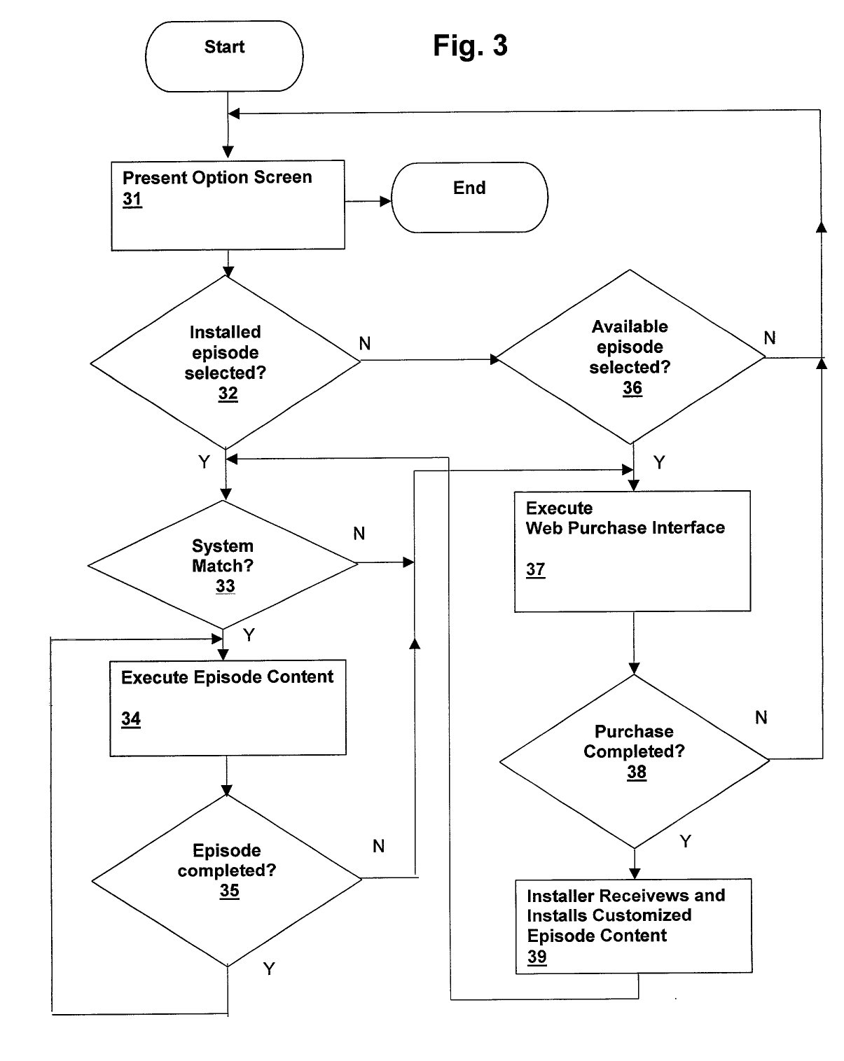

Referring now to FIG. 3, operation of software embodying a method of the present invention within end-user computer 14 is depicted. Game rack user interface 27, presents an option screen (step 31) that presents both installed episodes of a game and episodes that are available for download from game distribution server 14. The presentation screen may be updated by polling game distribution server 14. If an installed episode is selected by the game user (decision 32), the episode software checks for a match of the end-user computer 14 system info (decision 33) and if the end-user computer 14 is the system for which the episode is customized, the episode content is executed (step 34). If the system does not match (decision 33) or an available episode was selected (instead of an installed episode) (decision 36), a web purchase interface is provided to the game user (step 37) so that the game user may purchase the episode selected. When purchase is complete (e.g. account/credit card information is validated), end-user computer 14 will receive a customized download of episode content and the installer installs the customized episode content on end-user computer 14 (step 39). After installation, the system is checked for a match (decision 33) and the episode content is executed (step 34).

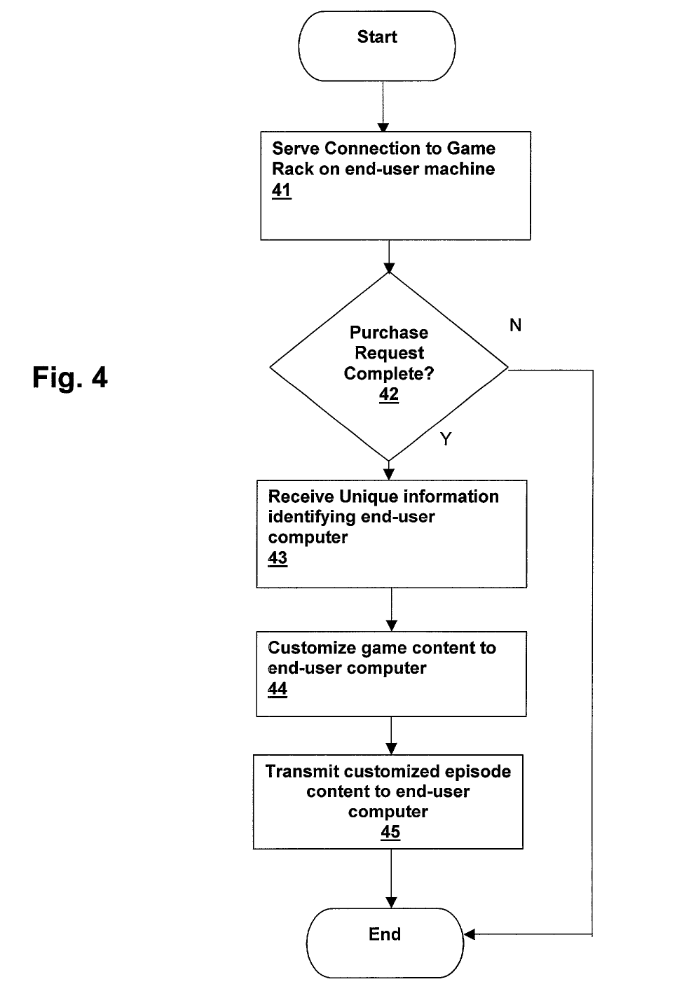

Referring now to FIG. 4, operation of software embodying a method of the present invention within game distribution server 12 is depicted. The connection to game rack user interface 27 within end-user computer 14 is served (step 41), providing an interface for purchase and download of game content. When purchase of an episode is complete (decision 42), information is received from end-user computer 14 that uniquely identifies end-user computer 14 (step 43). The game content is then customized to the particular end-user computer 14 so that the episode content will only execute on end used computer 14 (step 44) and the customized episode content is then downloaded to end-user computer 14 (step 45). Customization of the game content (step 44) may be performed by modifying program instructions or data so that the game content will perform a check for the particular system as specified by the information received from end-user computer 14 or the episode may be encrypted using a key derived from the information received. If the encryption method is used, the security module 27 within end-user software 27 will decrypt the episode using local system information, thereby providing execution only within end-user computer 14.

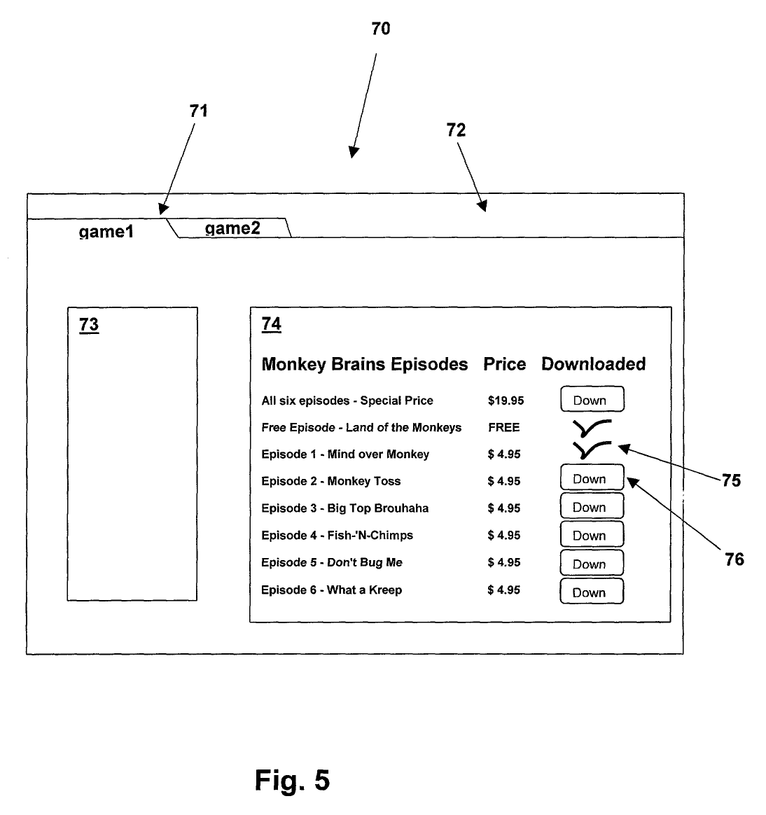

Referring now to FIG. 5, a game rack user interface 70 in accordance with a preferred embodiment of the invention is depicted. Game tabs 71 permit a game user to select between game screens. A logo area and control area 72 is provided for screen controls, presentation of announcements and game rack logo. Within a game screen graphical area 73 may contain a graphic or icon identifying a particular game. Episode list area 74 lists the installed and available episodes for a particular game. As illustrated, the name of the episode, the price and alternatively a download button or a mark indicating the installed/downloaded state of an episode may all be depicted in a manner organized to permit the game user to start installed episodes or purchase available episodes for use.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for downloading game content to an end-user computer having a visual display, said end-user computer further coupled to a game distribution server via an Internet connection, said method comprising:
presenting a list of game episodes on said visual display with an indication of available episodes and previously installed episodes, said presentation made from a game interface executing within said end-user computer;
in response to a user selection of a given one of said available episodes, transmitting a request to said game distribution server to commence purchase of said given episode; and
receiving said given episode and installing it on said end-user computer.

2. The method of claim 1, further comprising updating said list of game episodes such that said given episode is displayed as an installed episode.

3. The method of claim 1, wherein said transmitting further transmits information uniquely identifying said end-user computer and wherein said receiving receives an episode that is customized to only execute on said end-user computer.

4. The method of claim 3, further comprising:
executing said game interface from a second end-user computer;
determining whether or not said given episode is customized to said second end-user computer; and
in response to determining that said given episode is not customized to said second end-user computer, presenting a list of game episodes on said visual display with an indication of available episodes including said given episode whereby a user of said second end-user computer may purchase said given episode customized to said second end-user computer.

5. The method of claim 1, further comprising in response to a user selection of a given one of said previously installed episodes, executing said given one of said previously installed episodes.

6. The method of claim 1, further comprising:
receiving a request at said game distribution server to download said given episode to said end-user computer;
transmitting information from said end-user computer to said game distribution server that uniquely identifies said end-user computer;
second receiving said information at said game distribution server;
customizing said given episode at said game distribution server so that said given episode is only executable on said end-user computer; and
transmitting said given episode to said end-user computer, in response to completing said customizing.

7. The method of claim 1, wherein said presenting is made in response to completion of an episode on said end-user computer, whereby an available episode may be purchased to provide subsequent game content.

8. A method for downloading game content to an end-user computer having a visual display, said end-user computer further coupled to a game distribution server via an Internet connection, said method comprising:
receiving a request at said game distribution server to download said game content to said end-user computer;
second receiving information uniquely identifying said end-user computer at said game distribution server;
customizing said game content at said game distribution server so that said game content is only executable on said end-user computer; and
transmitting said game content to said end-user computer, in response to completing said customizing.

9. The method of claim 8, wherein said game content is an episode of a game, wherein said receiving receives a request for downloading said episode and wherein said customizing and said transmitting customize and transmit said episode.

10. The method of claim 8, wherein said customizing modifies executable program code within said game content, so that said game content will execute only on said end-user computer.

11. The method of claim 8, wherein said customizing modifies data structures within said game content, so that executable program code within said game content may compare said data structure with information unique to said end-user computer to determine whether said game content is validly installed.

12. A computer program product comprising signal-bearing media containing program instructions for execution on an end-user computer, said program instructions comprising program instructions for:
presenting a list of game episodes on said visual display with an indication of available episodes and previously installed episodes, said presentation made from a game interface executing within said end-user computer;
in response to a user selection of a given one of said available episodes, transmitting a request to said game distribution server to commence purchase of said given episode; and
receiving said given episode and installing it on said end-user computer.

13. The computer program product of claim 12, further comprising program instructions for updating said list of game episodes such that said given episode is displayed as an installed episode, subsequent to said receiving said given episode.

14. The computer program product of claim 12, wherein said program instructions for transmitting further transmit information uniquely identifying said end-user computer and wherein said program instructions for receiving receive an episode that is customized to execute only on said end-user computer.

15. The computer program product of claim 12, further comprising program instructions for:
executing said game interface from a second end-user computer;
determining whether or not said episode is customized to said second end-user computer; and
in response to determining that said episode is not customized to said second end-user computer, presenting a list of game episodes on said visual display with an indication of available episodes including said given episode whereby a user of said second end-user computer may purchase said given episode customized to said second end-user computer.

16. The computer program product of claim 12, further comprising program instructions for executing said one of said previously installed episodes in response to a user selection of one of said previously installed episodes.

17. The computer program product of claim 12, wherein said program instructions for presenting present said list in response to completion of an episode on said end-user computer, whereby an available episode may be purchased to provide subsequent game content.

18. A computer program product comprising signal-bearing media containing program instructions for execution on a game distribution server, said program instructions comprising program instructions for:
receiving a request at said game distribution server to download game content to an end-user computer;
second receiving information uniquely identifying said end-user computer at said game distribution server;
customizing said game content at said game distribution server so that said game content is only executable on said end-user computer; and
transmitting said game content to said end-user computer, in response to completing said customizing.

19. The computer program product of claim 18, wherein said game content is an episode of a game, wherein said program instructions for receiving receive a request for downloading said episode and wherein said program instructions for customizing and transmitting customize and transmit said episode.

20. The computer program product of claim 18, wherein said program instructions for customizing modify executable program code within said game content, so that said game content will execute only on said end-user computer.

21. The computer program product of claim 18, wherein said program instructions for customizing modify data structures within said game content, so that executable program code within said game content may compare said data structure with information unique to said end-user computer to determine whether said game content is validly installed.

22. A system for downloading game content, comprising:
a network;
a game distribution server coupled to said network; and
an end-user computer having a visual display and coupled to said network, wherein said end-user computer comprises a processor for executing program instructions and a memory coupled to said processor for containing program instructions and data, wherein said program instructions
present a list of game episodes on said visual display with an indication of available episodes and previously installed episodes, said presentation made from a game interface executing within said end-user computer,
in response to a user selection of a given one of said available episodes, transmitting a request to said game distribution server to commence a purchase of said given episode, and
receive said given episode and install it on said end-user computer.

23. The system of claim 22, wherein said program instructions further update said list of game episodes such that said given episode is displayed as an installed episode.

24. The system of claim 22, wherein said program instructions further transmit information uniquely identifying said end-user computer and wherein said receiving receives an episode that is customized to only execute on said end-user computer.

25. The system of claim 24, wherein said program instructions further determine whether or not said episode is customized to said end-user computer and in response to determining that said episode is not customized to said end-user computer, present a list of game episodes on said visual display with an indication of available episodes including said given episode whereby a user of said end-user computer may purchase said given episode customized to said end-user computer.

26. The system of claim 22, wherein said program instructions further execute said one of said previously installed episodes in response to a user selection of one of said previously installed episodes.

27. The system of claim 22, wherein program instructions present said list in response to completion of an episode on said end-user computer, whereby an available episode may be purchased to provide subsequent game content.

28. The system of claim 22, wherein said game distribution server comprises a server processor for executing server program instructions and a server memory coupled to said server processor for containing said server program instructions and server data, wherein said program server instructions
receive a request at said game distribution server to download said given episode to said end-user computer,
receiver information from said end-user computer to said game distribution server that uniquely identifies said end-user computer,
customize said given episode at said game distribution server so that said given episode is only executable on said end-user computer, and
transmit said given episode to said end-user computer, in response to completing said customizing.

29. A system for downloading game content, comprising:
a network;
an end-user computer coupled to said network; and a game distribution server coupled to said network, wherein said game distribution server comprises a processor for executing program instructions and a memory coupled to said processor for containing program instructions and data, wherein said program instructions
receive a request at said game distribution server to download said game content to said end-user computer;
second receive information uniquely identifying said end-user computer at said game distribution server;
customize said game content at said game distribution server so that said game content is only executable on said end-user computer; and
transmit said game content to said end-user computer, in response to completing said customizing.

30. The system of claim 29, wherein said game content is an episode of a game, wherein said program instructions receive a request for downloading said episode and customize and transmit said episode in response to receiving said request.

31. The system of claim 29, wherein said program instructions modify executable program code within said game content, so that said game content will execute only on said end-user computer.

32. The system of claim 29, wherein said program instructions modify data structures within said game content, so that executable program code within said game content may compare said data structure with information unique to said end-user computer to determine whether said game content is validly installed.
